(19) United States
(12) Patent Application Publication
(10) Pub. No.: US 2026/0111472 A1
(43) Pub. Date: Apr. 23, 2026

(54) ONLINE VEHICLE ISSUE RESOLUTION SERVICES

(71) Applicant: GM GLOBAL TECHNOLOGY OPERATIONS LLC, Detroit, MI (US)

(72) Inventors: Prakash M. PERANANDAM, Rochester Hills, MI (US); Ramesh S, Troy, MI (US); Arun ADITHTHAN, Sterling Heights, MI (US); Armando Antonio BELTRAN PACHECO, Rochester Hills, MI (US); Azeem SARWAR, Rochester Hills, MI (US)

(21) Appl. No.: 18/921,846

(22) Filed: Oct. 21, 2024

(51) Int. Cl. G06F 16/335

(52) U.S. Cl. CPC G06F 16/335

(57) ABSTRACT

A vehicle system includes a conversion module, a control module in communication with the conversion module, and an alert module in communication with the control module. The conversion module is configured to receive vehicle specific information and user manuals and generate a plurality of embeddings for the vehicle specific information and user manuals. The control module is configured to receive the plurality of embeddings and an input query from a user specific to a vehicle, identify vehicle information for the vehicle based on the input query, and generate a response specific to the vehicle based on the vehicle information and the plurality of embeddings in response to the input query. The alert module is configured to generate and transmit a notification including the response for the user. Other example vehicle systems and control methods are also disclosed.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to online vehicle issue resolution services, and more particularly to vehicle systems and control methods for vehicle query resolution services.

Vehicles often include printed user manuals providing information about the vehicles. When vehicle issues or queries arise, users can look to the user manuals for answers or guidance. Typically, user manuals are not vehicle specific. Instead, each user manual is generic to multiple vehicles variants of the same model but having different manufacturing options.

### SUMMARY

A vehicle system for vehicle query resolution services, includes a conversion module, a control module in communication with the conversion module, and an alert module in communication with the control module. The conversion module is configured to receive vehicle specific information and user manuals and generate a plurality of embeddings for the vehicle specific information and user manuals. The control module is configured to receive the plurality of embeddings and an input query from a user specific to a vehicle, identify vehicle information for the vehicle based on the input query, and generate a response specific to the vehicle based on the vehicle information and the plurality of embeddings in response to the input query. The alert module is configured to generate and transmit a notification including the response for the user.

In other features, the response specific to the vehicle includes at least one recommendation specific to the vehicle.

In other features, the vehicle system includes a vehicle control module positioned in the vehicle and in communication with the alert module. The vehicle control module is configured to control at least one operation of the vehicle based on the at least one recommendation specific to the vehicle.

In other features, the vehicle control module is configured to control at least one operation of the vehicle based on the at least one recommendation specific to the vehicle in response to a user input indicating approval of the at least one recommendation.

In other features, the response includes at least one of a recommendation to obtain a vehicle application or service, and an answer is currently unavailable.

In other features, the control module includes a large language model configured to generate the response specific to the vehicle based on the vehicle information and the plurality of embeddings.

In other features, the plurality of embeddings for the vehicle specific user manuals are a plurality of first embeddings, and the vehicle system further includes a crowdsourcing module in communication with the control module, the crowdsourcing module configured to receive a plurality of previous input queries and a corresponding plurality of responses to the previous input queries, determine subsets of frequently asked queries from the input queries, the subsets of frequently asked queries specific to different vehicle models, and generate a plurality of second embeddings for the subsets of frequently asked queries specific to the different vehicle models and their corresponding responses.

In other features, the control module is configured to generate the response specific to the vehicle based on the vehicle information, the plurality of first embeddings, and the plurality of second embeddings in response to the input query.

In other features, the plurality of responses to the previous input queries include at least one response annotated by a technician.

In other features, the control module is configured to receive at least one condition associated with the vehicle and generate the response specific to the vehicle based on the vehicle information, the plurality of embeddings, and the at least one condition associated with the vehicle in response to the input query.

In other features, the at least one condition includes at least one of a vehicle condition detected by a vehicle sensor, a weather condition received from an external source, or a road condition received from an external source.

In other features, the control module is configured to receive a plurality of input queries, identify a set of related input queries from the plurality of input queries for which no response is available, and in response to the set of related input queries being greater than a threshold, generate a notification for a manufacturer indicating a desired vehicle feature based on the related input queries.

A vehicle control method for vehicle query resolution services, includes generating a plurality of embeddings based on vehicle specific information and user manuals, receiving an input query from a user specific to a vehicle, identifying vehicle information for the vehicle based on the input query, generating a response with at least one recommendation specific to the vehicle based on the vehicle information and the plurality of embeddings in response to the input query, and controlling at least one operation of the vehicle based on the at least one recommendation specific to the vehicle.

In other features, controlling the at least one operation of the vehicle includes automatically controlling the at least one operation of the vehicle in response to the at least one recommendation.

In other features, the vehicle control method further includes receiving a user input indicating approval of the at least one recommendation specific to the vehicle.

In other features, controlling the at least one operation of the vehicle includes controlling the at least one operation of the vehicle based on the at least one recommendation specific to the vehicle in response to the user input.

In other features, the plurality of embeddings for the vehicle specific user manuals are a plurality of first embeddings, and the vehicle control method further includes receiving a plurality of previous input queries and a corresponding plurality of responses to the previous input queries, determining subsets of frequently asked queries from the input queries, the subsets of frequently asked queries specific to different vehicle models, and generating a plurality of second embeddings for the subsets of frequently asked queries specific to the different vehicle models and their corresponding responses.

In other features, generating the response specific to the vehicle includes generating the response based on the vehicle information, the plurality of first embeddings, and the plurality of second embeddings in response to the input query.

In other features, the vehicle control method further includes receiving at least one condition associated with the vehicle.

In other features, generating the response specific to the vehicle includes generating the response based on the vehicle information, the plurality of embeddings, and the at least one condition associated with the vehicle in response to the input query.

In other features, the vehicle control method further includes receiving a plurality of input queries, identifying a set of related input queries from the plurality of input queries for which no response is available, and in response to the set of related input queries being greater than a threshold, generating a notification for a manufacturer indicating a desired vehicle feature based on the related input queries.

A vehicle system for vehicle query resolution services, includes a conversion module, a control module in communication with the conversion module, and a vehicle control module positioned in the vehicle. The conversion module is configured to receive vehicle specific information and user manuals and generate a plurality of embeddings for the vehicle specific information and user manuals. The control module includes a large language model configured to receive the plurality of embeddings and an input query from a user specific to a vehicle, identify vehicle information for the vehicle based on the input query, and generate a response with at least one recommendation specific to the vehicle based on the vehicle information and the plurality of embeddings in response to the input query. The vehicle control module configured to control at least one operation of the vehicle based on the at least one recommendation specific to the vehicle.

In other features, the vehicle control module configured to control the at least one operation of the vehicle based on the at least one recommendation in response to a user input indicating approval of the at least one recommendation.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram of an example vehicle system for vehicle query resolution services associated with a vehicle, according to the present disclosure;

FIG. 2 is a block diagram of another example vehicle system for vehicle query resolution services, in which the vehicle system implements a crowdsource-based architecture, according to the present disclosure;

FIG. 3 is a block diagram of another example vehicle system for vehicle query resolution services, in which the vehicle system provides customized responses based on conditions associated with a vehicle, according to the present disclosure; and

FIGS. 4-9 are flowcharts of example control processes for vehicle query resolution services.

In the drawings, reference numbers may be reused to identify similar and/or identical elements.

### DETAILED DESCRIPTION

Vehicles often include printed user manuals providing information about the vehicles. Such manuals are not vehicle specific and instead are generic to multiple vehicles variants. As such, when vehicle issues or queries arise, users are often provided with generic answers/guidance, unclear answers/guidance or no answers/guidance at all. Additionally, in some cases, users are unable to effectively conceptualize and communicate the vehicle issues or queries to rely on the user manual for answers. Further, even if desired answers/guidance is provided, ascertaining such answers/guidance is time consuming for users.

The vehicle systems and control methods according to the present disclosure provide technical solutions for enhancing vehicle-user experiences by enabling online services providing recommendations and resolutions for vehicle issues at the user comfort. Then, in some implementations, the vehicle systems and control methods enable vehicle control based on the provided recommendations. In such examples, the vehicle systems and control methods include, for example, sophisticated digitalization of user queries, vehicle information, vehicle status and a database of crowdsourced and technician augmented recommendations for consumption by a model (e.g., a large language model, etc.) and customized solutions/responses from the model. With such technical configurations, the vehicle systems and control methods provide for real-time customized vehicle issue resolution over various modalities and vehicle control (when appropriate) based on the real-time customized vehicle issue resolution.

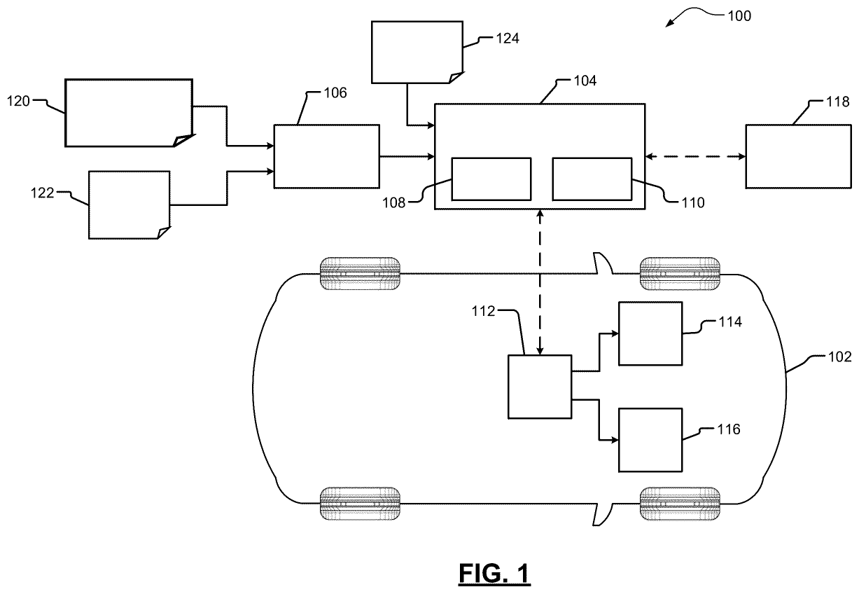

Referring now to FIG. 1, a block diagram of an example vehicle system 100 is presented for vehicle query resolution services associated with a vehicle 102. As shown in FIG. 1, the vehicle system 100 generally includes a control module 104 and a conversion module 106 external to the vehicle 102. The control module 104 is shown as including a language model 108, such as a large language model (LLM) and an alert module 110. Additionally, in various embodiments, the vehicle system 100 may optionally include a control module 112, a vehicle control module 114, and a display module 116 all internal to or positioned in the vehicle 102, and a user device 118, such as a phone, tablet, etc. In various embodiments, the control module 104, the conversion module 106, and the alert module 110 may form a cloud-based architecture for online vehicle issue resolution services.

Although FIG. 1 illustrates the vehicle system 100 as including specific dedicated modules, it should be appreciated that one or more other modules may be employed if desired. For example, any combination of the modules (e.g., the control module 104 and the conversion module 106, and the control module 112, the vehicle control module 114 and the display module 116, etc.) and/or the functionality thereof may be integrated into a single module or multiple different modules. Additionally, in some examples, some of the modules may be standalone modules if desired. For instance, in some embodiments, the alert module 110 may be separate from (but remain in communication with) the control module 104.

The vehicle system 100 of FIG. 1 may be employable in any suitable vehicle, such as autonomous vehicles, semi-autonomous vehicles, bikes, drones, airplanes, marine vehicles, etc. Additionally, the vehicle system 100 may be applicable to electric vehicles (e.g., a pure electric vehicle, a plug-in hybrid electric vehicle, etc.) and internal combustion engine (ICE) vehicles. In the example of FIG. 1, the vehicle system 100 is employed in the vehicle 102 (e.g., an autonomous vehicle).

In the example of FIG. 1, the conversion module 106, the alert module 110, the control module 112, and the user device 118 are in communication with the control module 104. In such examples, the control module 104 may receive and/or transmit signals between each of the conversion module 106, the alert module 110, the control module 112, and the user device 118. Additionally, in the vehicle 102, the vehicle control module 114 and the display module 116 are in communication with the control module 112. These internal modules may receive and/or transmit signals between each other via a network, such as a controller area network (CAN) and signals.

With continued reference to FIG. 1, the conversion module 106 generally receives one or more inputs for use in converting text into usable digitalized information. More specifically, in FIG. 1, the conversion module 106 receives vehicle specific user manuals 120 and parameters 122. In such examples, the vehicle specific user manuals 120 may include text from general user manuals and feature specific information that combinedly can address various different vehicles. For example, the user manual (or the text thereof) is specific to a particular vehicle make and model with specified manufacturing options when provided with the unique vehicle identification number (VIN). In various embodiments, one of the user manuals 120 may be specific to the vehicle 102. In other examples, none of the user manuals 120 may be specific to the vehicle 102.

Additionally, the parameters 122 may include specific defined parameters for use in generating embeddings. In such examples, the parameters 122 may include, for example, a chunk size parameter (e.g., a maximum number of tokens allowed for each chunk or section of extracted text from the user manuals 120), an overlap parameter (e.g., a maximum number of overlapping characters between different chunks of extracted text), etc. As examples only, the chunk size may be an empirical data-based range selection.

Then, the conversion module 106 generates embeddings for the received vehicle specific user manuals 120 and information from the crowdsourced database. Such embeddings can be generated periodically based on the received parameters 122. Generally, the generated embeddings may represent values for objects, such as text, images, etc. in the user manuals 120 that are used by the language model 108, as further explained below. In other words, the objects in the user manuals 120 are translated into a mathematical form based on traits each object may or may not have. More specifically, the embeddings may be created through a neutral network or another suitable deep machine learning process. The embeddings capture complex relationships and semantics in the form of vectors. Such vectors can be projected into a muti-dimensional vector space if desired.

The conversion module 106 may implement any suitable data pre-processing technique on the user manuals 120 to enable generation of the embeddings. For example, the conversion module 106 may use a content splitting and chunking technique, such as a fixed size chunking method, a content aware chunking method, a recursive chunking method, a semantic chunking method, etc. to build a retrieval augmented generation (RAG) system and prompt template.

In FIG. 1, the control module 104 also generally receives one or more inputs. For example, the control module 104 receives the generated embeddings from the conversion module 106 and an input query from a user specific to the vehicle 102. For example, the user may ask a question or a request via the user device 118 and/or via a module in the vehicle 102, such as the display module 116. In such examples, the user may input the query via an application on the user device 118 and/or the display module 116. Such input may be verbalized and/or provided by text. If the query is verbalized, the user device 118 and/or the display module 116 (or the control module 112) may convert the audio into text. The user device 118 and/or the display module 116 (via the control module 112) may then transmit the query to the control module 104. As examples only, the input query may include “where is a trunk release”, “why is a light coming on”, “how do I change the air filter”, etc.

The control module 104 also receives general vehicle information 124 for use in identifying vehicle information for a specific vehicle, such as the vehicle 102. For example, the control module 104 may have access to a database including vehicle information 124 and/or may otherwise receive the vehicle information 124. In such examples, the control module 104 may identify a specific vehicle based on the received input query and the vehicle information 124. For instance, the input query provided by the user may include a VIN specific to the vehicle 102. The VIN may be automatically added to the input query (by the application on the user device 118 and/or the display module 116) prior to transmitting the input query to the control module 104. In other examples, the user or the control module 104 may input or append the VIN when generating the input query. Once the VIN is known, the control module 104 may access the vehicle information 124 to locate specific details (e.g., make, model, manufacturing options, etc.) about the vehicle 102 based on the received VIN.

Then, the control module 104 generates a response specific to the vehicle 102 in response to the received input query. In such examples, the response is generated based on the vehicle information (e.g., the specific details) of the vehicle 102 and the embedding for the vehicle specific user manuals 120. For example, the language model 108 of the control module 104 may receive the input query and the vehicle information (or representative data thereof) and utilize the embeddings to find information from one or more of the vehicle specific user manuals 120 to generate a response to the input query. For instance, if the input query is “where is a trunk release” and the vehicle information provides the make, model, manufacturing options, etc. of the vehicle 102, the language model 108 can utilize the embeddings to generate a response of the location of the trunk release on the vehicle 102. In other examples, the response may be, for example, that an answer is unavailable. For instance, in response to the input query, the generated response may provide that currently, no answer is available (or no better answer is available), we will get back to you with a response, etc.

Next, the vehicle system 100 generates a notification including the response for the user. For example, the alert module 110 may generate a notification signal representative of the response and transmit this notification signal to the user device 118 and/or the control module 112 in the vehicle 102. If the notification signal is provided to the control module 112, the control module 112 may transmit a signal to the display module 116 and/or another suitable output device, which in turn provides a visual and/or audible representation of the response specific to the vehicle 102. Likewise, if the notification signal is provided to the user device 118, an application on the device 118 may provide a visual and/or audible representation of the response specific to the vehicle 102.

In some examples, the vehicle system 100 may take one or more actions based on the response. For example, once the response is received by the user device 118 and/or the control module 112, the user (e.g., a driver) may implement a vehicle control feature initiated with the vehicle control module 114 based on the response. In such examples, the user may provide an input (e.g., to the display module 116, to the user device 118, etc.), which causes the control module 112 to transmit one or more control signals to the vehicle control module 114. Then, the vehicle control module 114 may control at least one operation of the vehicle 102 based on the control signals.

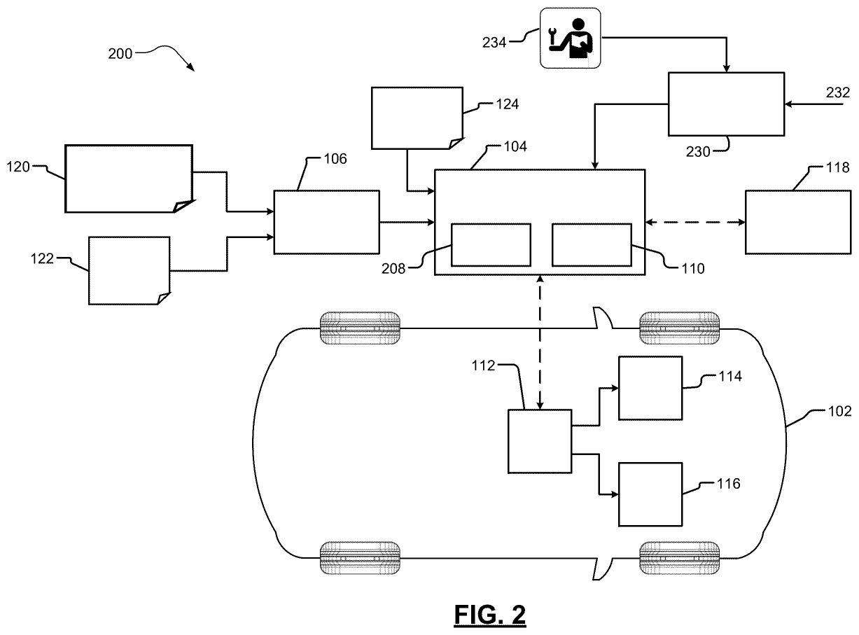

In various embodiments, the vehicle systems herein may implement crowdsource-based architecture for online vehicle issue resolution services. For example, FIG. 2 depicts a vehicle system 200 for vehicle query resolution services associated with the vehicle 102. The vehicle system 200 is similar to the vehicle system 100 but with a crowdsource-based architecture implemented.

For example, the vehicle system 200 is shown as including the control module 104, the conversion module 106, the alert module 110, the control module 112, the vehicle control module 114, the display module 116 and the user device 118 of FIG. 1, and a crowdsourcing module 230 in communication with the control module 104. The control module 104, the conversion module 106, the alert module 110, the control module 112, the vehicle control module 114, the display module 116 and the user device 118 of the vehicle system 200 generally function as explained above relative to the vehicle system 100 unless otherwise stated below.

As shown in FIG. 2, the control module 104 includes a language model 208. In the example of FIG. 2, the language model 208 is a multimodal LLM that can process varies types of media, such as video, image, text, audio, etc. As such, in this example, the use of a multimodal LLM allows users to provide different forms of media as an input query. For example, the input query from the user may include an image, an audio clip, a video clip, text, etc. and/or a combination thereof. In other examples, the language model 208 may be another suitable language model if desired.

The crowdsourcing module 230 generates additional embeddings based on crowdsourced data for use in generating responses to input queries. For example, the crowdsourcing module 230 receives previous input queries from various users and responses to some or all of the input queries. This information provided to the crowdsourcing module 230 is shown as an input 232 in FIG. 2. Such input queries and responses may be provided by the control module 104 if desired. In such examples, the crowdsourcing module 230 may store the input queries and responses in a database. For instance, the crowdsourcing module 230 may implement a database with a metadata index that links a received input query to a response for that input query.

In some examples, some of the responses provided to the crowdsourcing module 230 may be annotated by a technician 234. For instance, if an input query is a first of its kind (e.g., first asked query) or a response is unknown by the vehicle system 200, the technician 234 may provide an annotated response to the input query.

The crowdsourcing module 230 then determines subsets of frequently asked queries from the input queries, where each subset of frequently asked queries is specific to a different vehicle model. In such examples, the crowdsourcing module 230 may identify the subsets of frequently asked queries based on a recurrence threshold. In this example, the recurrence threshold may represent a number of times a similar query has been asked.

Then, the crowdsourcing module 230 generates embeddings in a periodic fashion for the subsets of frequently asked queries specific to the different vehicle models and their corresponding responses. In such examples, the embeddings for the subsets of frequently asked queries may be similar to the embedding for the vehicle specific user manuals 120 explained above. For instance, the embeddings for the subsets of frequently asked queries may be in the form of form of vectors and represent values for objects in the frequently asked queries and responses. The embeddings for the subsets of frequently asked queries are then provided to the control module 104.

The control module 104 then generates a response specific to the vehicle 102 in response to the input query (e.g., an image, an audio clip, a video clip, text, etc. and/or a combination thereof). For example, the language model 208 receives the input query and the vehicle information specific to the vehicle 102 and then utilizes the received embeddings from the conversion module 106 and the crowdsourcing module 230 to generate a response specific to the vehicle 102. In such examples, the generated response may include vehicle specific details, one or more recommendations specific to the vehicle 102, etc.

Next, the alert module 110 may generate a notification signal representative of the response and transmit this notification signal to the user device 118 and/or the control module 112 in the vehicle 102, as explained above. In such examples, the notification signal may include the one or more recommendations referenced above.

In various embodiments, the vehicle system 200 may take one or more actions based on the response. For example, if the response is provided to the control module 112 with a recommendation specific to the vehicle 102, the control module 112 may generate one or more control signals based on the received recommendation for the vehicle control module 114, which in turn may control at least one operation of the vehicle 102. In such examples, the vehicle control module 114 may automatically implement the recommendation without user interaction, such as enable or disable a feature.

In other examples, user interaction may be required before the vehicle control module 114 implements the recommendation. For example, the response with the recommendation may be provided to the control module 112 and then displayed by the display module 116 and/or provided to and displayed by the user device 118. In such examples, the user device 118 may be in communication with the control module 112. Then, the user can select or otherwise provide an input to indicate approval of the recommendation. In response to the user input, the control module 112 may generate one or more control signals based on the received recommendation for the vehicle control module 114, which in turn may control at least one operation of the vehicle 102.

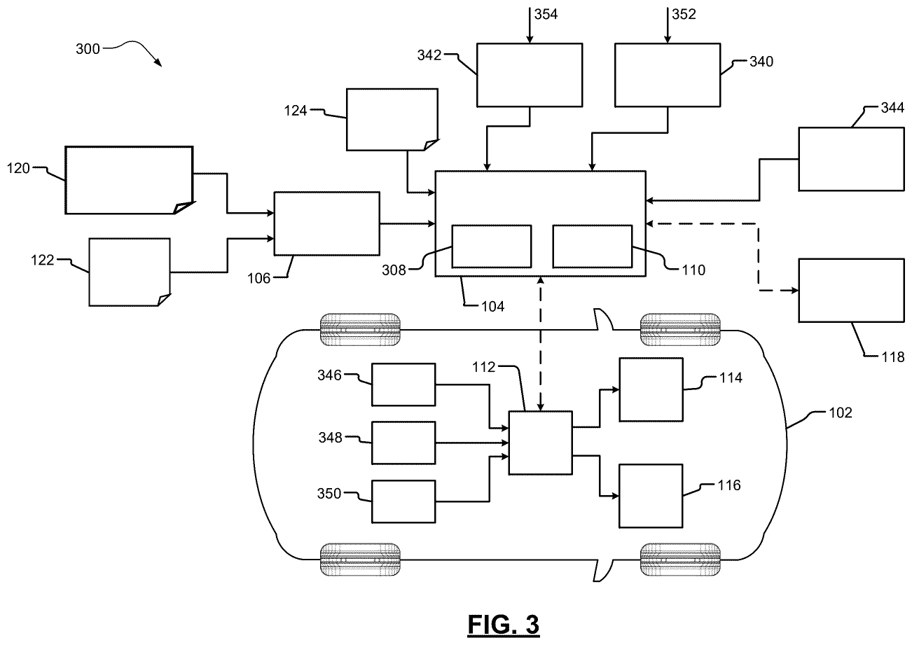

In various embodiments, the vehicle systems herein may customize responses based on conditions associated with a vehicle, such as the vehicle 102. For example, FIG. 3 depicts a vehicle system 300 for vehicle query resolution services associated with the vehicle 102. The vehicle system 300 is similar to the vehicle system 100 but with a condition-based architecture implemented.

In FIG. 3, the vehicle system 300 is shown as including the control module 104, the conversion module 106, the alert module 110, the control module 112, the vehicle control module 114, the display module 116 and the user device 118 of FIG. 1. Additionally, the vehicle system 300 includes an issue module 340, a services module 342, at least one external source 344, and multiple vehicle sensors 346, 348, 350 all in communication with the control module 104. In the example of FIG. 3, the control module 104, the conversion module 106, the alert module 110, the control module 112, the vehicle control module 114, the display module 116 and the user device 118 of the vehicle system 200 generally function as explained above relative to the vehicle system 100 unless otherwise stated below.

As shown in FIG. 3, the control module 104 includes a language model 308. In the example of FIG. 3, the language model 308 may be a specialized fine-tuned LLM. In such examples, the language model 308 may be trained based on specific, labeled datasets to improve performance. In other examples, the language model 308 may be another suitable language model if desired.

The issue module 340 may generate additional embeddings for use in generating responses. For example, the issue module 340 may receive one or more inputs 352 representing known vehicle issues (e.g., diagnostic trouble codes (DTCs), etc.), symptoms associated with the issues, and actions to take to address such issues. In such examples, the vehicle issues, symptoms, and actions may be provided as crowdsourced data, type allocation codes (TAC), etc. and stored in a database. The database may be updated periodically and/or in response to a defined event. The issue module 340 may then generate embeddings for the vehicle issues, symptoms, and actions. For instance, the embeddings may be in the form of form of vectors and represent values for corresponding vehicle issues, symptoms, and actions. In such examples, the embeddings are provided to the control module 104.

Additionally, the services module 342 may generate embeddings for use in generating responses. For example, the services module 342 may receive one or more inputs 354 representing known applications and services available for vehicles and system requirements and conditions for the applications and services. In such examples, the known applications and services may be generic to multiple vehicles (not specific to a particular vehicle). The known applications and services, and their system requirements and conditions may be stored in a database if desired. The services module 342 may then generate embeddings for the applications and services. For instance, the embeddings may be in the form of form of vectors and represent values for corresponding applications and services and their system requirements and conditions. In such examples, the embeddings are provided to the control module 104.

In the example of FIG. 3, the external source 344 and the vehicle sensors 346, 348, 350 can provide conditions associated with the vehicle 102 to the control module 104 for use in generating responses. For example, the external source 344 may be a weather station that provides a weather condition currently affecting the vehicle 102. In other examples, the external source 344 may provide a road condition associated with a road traveled on by the vehicle 102. Additionally, the vehicle sensors 346, 348, 350 may detect one or more vehicle conditions and/or vehicle statuses and provide such information to the control module 104 (e.g., via the control module 112).

The control module 104 then generates a response specific to the vehicle 102 in response to an input query received from a user. For example, the language model 308 in FIG. 3 receives the input query, the vehicle information specific to the vehicle 102, and the conditions associated with the vehicle 102 (e.g., from the external source 344 and/or one or more of the sensors 346, 348, 350). Then, based on this information, the language model 308 utilizes the received embeddings from the conversion module 106, the issue module 340, and the services module 342 to generate a response specific to the vehicle 102.

In such examples, the generated response may include customized recommendations for corrective and/or enabling actions to implement. For instance, the customized recommendations may include suggested software updates for the vehicle 102. In such examples, the control module 112 may implement such updates automatically and/or upon user approval.

In other examples, the customized recommendations may include vehicle control actions. For example, the vehicle system 300 may take one or more actions based on the response in a similar manner as the vehicle system 200. For instance, if the response is provided to the control module 112 with a customized recommendation, the control module 112 may automatically generate one or more control signals based on the received recommendation for the vehicle control module 114, which in turn may control at least one operation of the vehicle 102. In other examples, the control module 112 may wait until the user provides an input indicating approval of the recommendation before generating the control signal(s), as explained above.

In various embodiments, any one of the vehicle systems 100, 200, 300 may include one or more additional features for vehicle query resolution services. For example, in some embodiments, the control module 104 of the vehicle systems 100, 200, 300 may generate and transmit notifications to vehicle control modules and/or user devices providing recommendations to obtain a specific vehicle application, service, etc. Additionally, in some examples, the control module 104 may provide feedback (e.g., updates) to train any one of the language models 108, 208, 308. In doing so, the language models 108, 208, 308 may provide improved responses (e.g., recommendations, suggestion, answers, etc.) for user viewing and/or vehicle control. Further, the control module 104 may generate and transmit notifications to third parties, such as manufacturers (e.g., original equipment manufacturers, etc.) indicating a desired vehicle feature based on input queries from users. For instance, the control module 104 may receive multiple input queries, identify a set of related input queries from the input queries for which no response is available, and in response to the set of related input queries being greater than a threshold, generate a notification indicating a desired vehicle feature based on the related input queries.

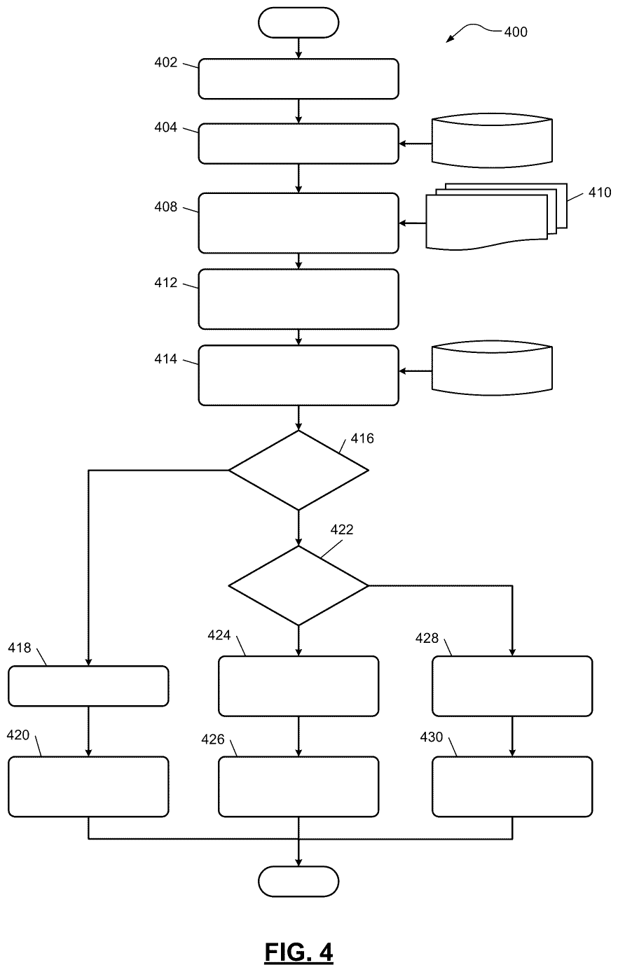

For example, FIG. 4 depicts one example control process 400 for implementing such features. In FIG. 4, the control process 400 begins at 402, where the control module 104 of any one of the vehicle systems 100, 200, 300 of FIGS. 1-3 reads or otherwise receives a current input query from a user and a VIN specific to a vehicle (e.g., the vehicle 102 of FIGS. 1-3). Then, the control process 400 proceeds to 404, where the control module 104 reads or otherwise receives past input queries from that same VIN. In this example, the past input queries may be accessed from question-and-answer database 406 that stores past input queries and response and linked VINs associated with the input queries. The control process 400 then proceeds to 408.

At 408, the control module 104 extracts involved vehicle sub-systems and corresponding features from the past input queries. For example, the control module 104 may extract information (e.g., functionality level information) relating to an infotainment sub-system and/or other suitable sub-systems in the vehicle and corresponding features of the infotainment sub-system and/or other suitable sub-systems. In such examples, this information may be extracted from domain knowledge artifacts 410. Then, the control process 400 proceeds to 412, where the control module 104 implements a model to search applications and services (e.g., applications and services metadata) for user needs. The control process 400 then proceeds to 414, where the control module 104 maps the needed applications and services to a set of applicable applications and services found in an applications and services database 416. Then, the control process 400 proceeds to 416.

At 416, the control module 104 determines whether the mapping is complete. For example, the control module 104 may determine if each needed application and service is mapped to an applicable application and service. If yes at 416, the control process 400 proceeds to 418, 420. The control module 104 groups the applicable applications and services needed by the user at 418, and then sends a notification (e.g., a targeted ad) to the vehicle (e.g., the control module 112) and/or the user device 118 with the applicable applications and services needed by the user. The control process 400 then ends as shown in FIG. 4.

However, if no at 416, the control process 400 proceeds to 422. At 422, the control module 104 determines whether features corresponding to the unmapped applications and services are available. If yes at 422, the control process 400 proceeds to 424, 426. For the available features, the control module 104 groups the applicable applications and services needed by the user at 424. Then, at 426, the control module 104 sends a notification (e.g., a targeted ad) to the vehicle (e.g., the control module 112) and/or the user device 118 with the applicable applications and services needed by the user. The control process 400 then ends as shown in FIG. 4.

However, if no at 422, the control process 400 proceeds to 428, 430. For the unavailable features, the control module 104 at 428 collects relevant information relating to the unavailable features, such as relevant input queries, situations in which the input queries were initiated, etc. Then, at 430, the control module 104 sends a notification to a third party, such as a manufacturer indicating user desired vehicle features. For example, the control module 104 may determine that a number of input queries relate to a similar unavailable feature and that no response is available for the input queries. If the number of input queries is greater than a threshold, the control module 104 sends a notification to the third party. The third party may then make such features available if desired. The control process 400 then ends as shown in FIG. 4.

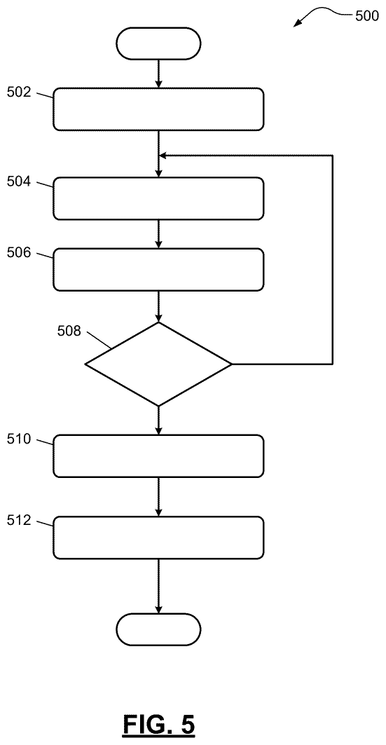

FIGS. 5-9 illustrate additional example control processes 500, 600, 700, 800, 900 for vehicle query resolution services and employable by any one of the vehicle systems 100, 200, 300 of FIGS. 1-3.

As shown in FIG. 5, the control process 500 begins at 502 where the conversion module 106 generates embeddings based on vehicle specific user manuals and provides the embeddings to the control module 104, as explained above. Then, the control process 500 proceeds to 504, where the control module 104 receives an input query specific to a vehicle from a user (e.g., via an application in the vehicle 102, via an application on the user device 118, etc.) as explained above. The control process 500 then proceeds to 506, where the control module 104 identifies vehicle information for the vehicle based on the input query. For instance, the input query provided by the user may include a VIN specific to the vehicle. Once the VIN is known, the control module 104 may access the vehicle information to locate specific details (e.g., make, model, manufacturing options, etc.) about the vehicle based on the received VIN. Next, the control process 500 proceeds to 508.

At 508, the control module 104 determines whether the input query is answerable. If no at 508, the control process 500 returns to 504. If yes at 508, the control process 500 proceeds to 510.

At 510, the control module 104 generates a response providing an answer, a recommendation, etc. to the input query. In such examples, the answer, the recommendation, etc. is specific to the vehicle and is based on the vehicle information and the embeddings. The control process 500 then proceeds to 512, where the control module 104 transmits a notification including the response for the user. For example, and as explained herein, the control module 104 (or the alert module 110) may generate a notification signal representative of the response and transmit this notification signal to the user device 118 and/or the control module 112 in the vehicle 102. The control process 500 then ends as shown in FIG. 5.

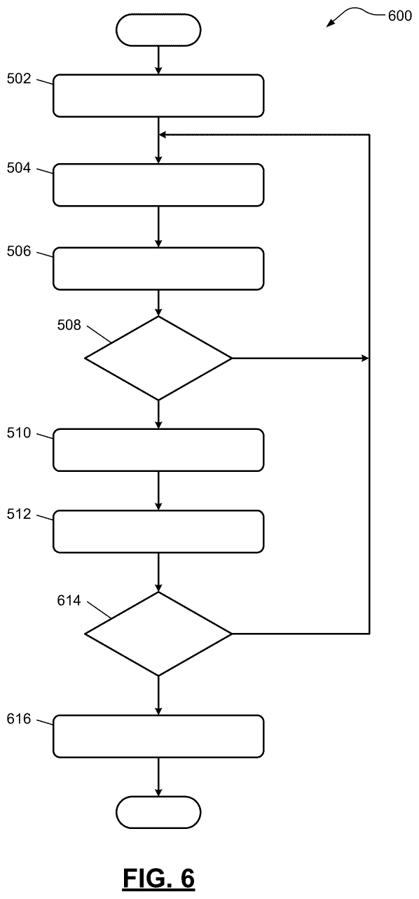

In FIG. 6, the control process 600 is similar to the control process 500 of FIG. 5 but includes additional steps. For example, and as shown in FIG. 6, the control process 600 includes 502, 504, 506, 508, 510, 512 of FIG. 5 as explained above, and then proceeds to 614. At 614, the control module 112 of the vehicle 102 determines whether the received recommendation is approved by the user (e.g., a driver, etc.). For example, and as explained above, the recommendation may be provided to the control module 112 and then displayed by the display module 116 and/or provided to and displayed by the user device 118. In such examples, the user device 118 may be in communication with the control module 112. Then, the user may provide an input to indicate approval of the recommendation. If no at 614, the control process 600 returns to 504. If yes at 614, the control process 600 proceeds to 616.

At 616, the vehicle control module 114 of the vehicle 102 controls at least one operation of the vehicle 102 based on the response. For example, once the user approves the recommendation, the control module 112 may generate one or more control signals based on the received recommendation for the vehicle control module 114, which in turn may control at least one operation of the vehicle 102. The control process 600 then ends as shown in FIG. 6.

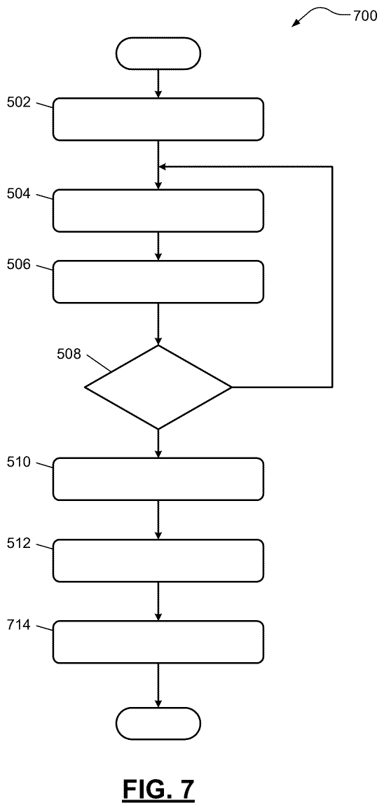

The control process 700 of FIG. 7 is similar to the control process 500 of FIG. 5 but includes an additional step. For example, and as shown in FIG. 7, the control process 700 includes 502, 504, 506, 508, 510, 512 of FIG. 5 as explained above, and then proceeds to 714. At 714, the vehicle control module 114 of the vehicle 102 controls at least one operation of the vehicle 102 based on the response. For example, in the control process 700, the vehicle control module 114 may automatically implement the recommendation without user interaction. The control process 700 then ends as shown in FIG. 7.

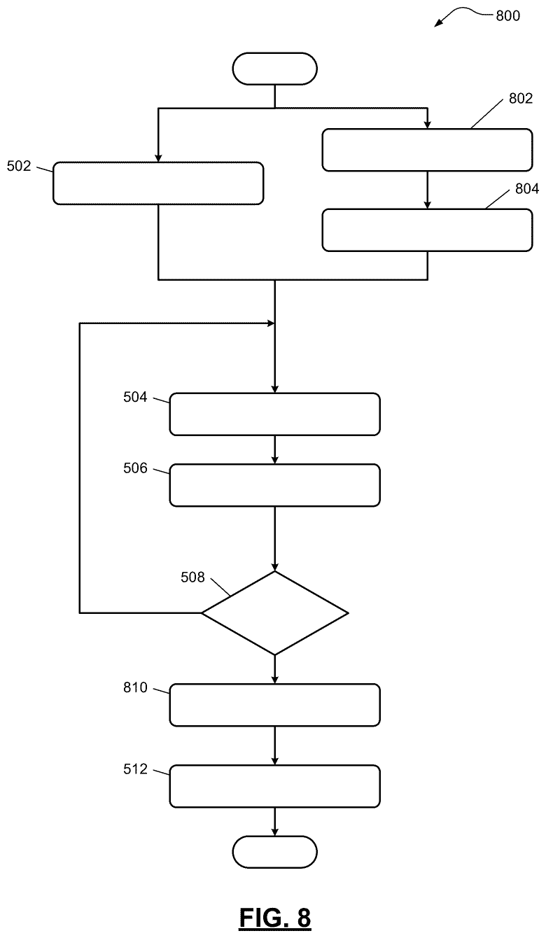

In FIG. 8, the control process 800 is similar to the control process 500 of FIG. 5 but includes additional steps. For example, and as shown in FIG. 8, the control process 800 begins at 502 of FIG. 5 as explained above and 802. At 802, the crowdsourcing module 230 of FIG. 2 determines subsets of frequently asked queries from received input queries, as explained above. In this example, each subset of frequently asked queries is specific to a different vehicle model. Then, the control process 800 proceeds to 804, where the crowdsourcing module 230 generates embeddings for the subsets of frequently asked queries specific to the different vehicle models and their corresponding responses, as explained above.

Next after 502, 804, the control process 800 proceeds to 504, 506, 508 of FIG. 5 as explained above. Then, the control process 800 proceeds to 810. At 810, the control module 104 generates a response specific to the vehicle 102 in response to the input query (received at 504), as explained above. For example, the control module 104 utilizes the embeddings from the conversion module 106 and the crowdsourcing module 230 to generate the response. Then, the control process 800 proceeds to 512 of FIG. 5 as explained above. The control process 800 then ends as shown in FIG. 8.

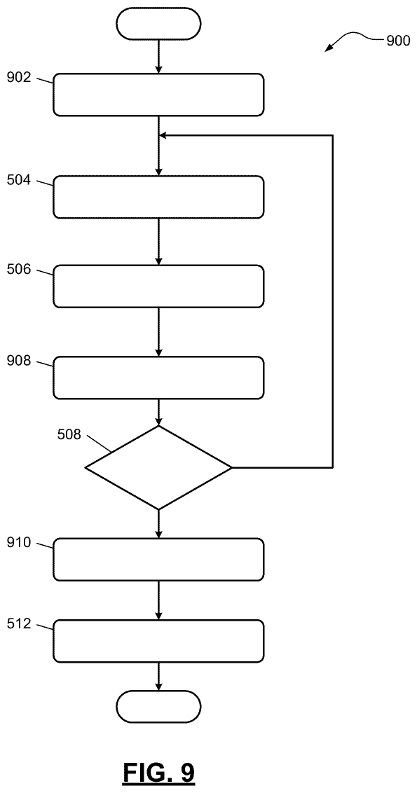

The control process 900 of FIG. 9 is similar to the control process 500 of FIG. 5 but includes an additional step. For example, and as shown in FIG. 9, the control process 900 begins as 902 where multiple sets of embeddings are generated. For example, the conversion module 106 generates embeddings based on vehicle specific user manuals and provides the embeddings to the control module 104, as explained above relative to 502 of FIG. 2. Additionally, and as explained above, the issue module 340 and the services module 342 of FIG. 3 generate embeddings for known vehicle issues, symptoms, and actions and for known applications and services, respectively. The issue module 340 and the services module 342 provide the embeddings to the control module 104. Next, the control process 900 proceeds to 504, 506 of FIG. 5 as explained above, and then to 908.

At 908, the control module 104 receives one or more conditions associated with the vehicle 102. For example, and as explained above, the control module 104 may receive a weather condition currently affecting the vehicle 102 from the external source 344, a road condition associated with a road being traveled on by the vehicle 102 from the external source 344, vehicle conditions from the vehicle sensors 346, 348, 350 in the vehicle 102, etc. Next, the control process 900 proceeds to 508 of FIG. 5 as explained above, and then to 910.

At 910, the control module 104 generates a response specific to the vehicle 102 in response to the input query (received at 504), as explained above. For example, the control module 104 utilizes the embeddings from the conversion module 106, the issue module 340, and the services module 342 to generate the response. Then, the control process 900 proceeds to 512 of FIG. 5 as explained above. The control process 900 then ends as shown in FIG. 9.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed. ” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C. ” In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit. ” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), vehicle networks (CAN, LIN, Ethernet, etc.), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, applications, services, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle system for vehicle query resolution services, the vehicle system comprising:
a conversion module configured to receive vehicle specific information and user manuals and generate a plurality of embeddings for the vehicle specific information and user manuals;
a control module in communication with the conversion module, the control module configured to receive the plurality of embeddings and an input query from a user specific to a vehicle, identify vehicle information for the vehicle based on the input query, and generate a response specific to the vehicle based on the vehicle information and the plurality of embeddings in response to the input query; and
an alert module in communication with the control module, the alert module configured to generate and transmit a notification including the response for the user.

2. The vehicle system of claim 1, wherein the response specific to the vehicle includes at least one recommendation specific to the vehicle.

3. The vehicle system of claim 2, further comprising a vehicle control module positioned in the vehicle and in communication with the alert module, the vehicle control module configured to control at least one operation of the vehicle based on the at least one recommendation specific to the vehicle.

4. The vehicle system of claim 2, further comprising a vehicle control module positioned in the vehicle and in communication with the alert module, the vehicle control module configured to control at least one operation of the vehicle based on the at least one recommendation specific to the vehicle in response to a user input indicating approval of the at least one recommendation.

5. The vehicle system of claim 1, wherein the response includes at least one of:
a recommendation to obtain a vehicle application or service; and
an answer is currently unavailable.

6. The vehicle system of claim 1, wherein the control module includes a large language model configured to generate the response specific to the vehicle based on the vehicle information and the plurality of embeddings.

7. The vehicle system of claim 1, wherein:
the plurality of embeddings for the vehicle specific user manuals are a plurality of first embeddings; and
the vehicle system further includes a crowdsourcing module in communication with the control module, the crowdsourcing module configured to:
receive a plurality of previous input queries and a corresponding plurality of responses to the previous input queries;
determine subsets of frequently asked queries from the input queries, the subsets of frequently asked queries specific to different vehicle models; and
generate a plurality of second embeddings for the subsets of frequently asked queries specific to the different vehicle models and their corresponding responses.

8. The vehicle system of claim 7, wherein the control module is configured to generate the response specific to the vehicle based on the vehicle information, the plurality of first embeddings, and the plurality of second embeddings in response to the input query.

9. The vehicle system of claim 7, wherein the plurality of responses to the previous input queries include at least one response annotated by a technician.

10. The vehicle system of claim 1, wherein the control module is configured to:
receive at least one condition associated with the vehicle; and
generate the response specific to the vehicle based on the vehicle information, the plurality of embeddings, and the at least one condition associated with the vehicle in response to the input query.

11. The vehicle system of claim 10, wherein the at least one condition includes at least one of a vehicle condition detected by a vehicle sensor, a weather condition received from an external source, or a road condition received from an external source.

12. The vehicle system of claim 1, wherein the control module is configured to:
receive a plurality of input queries;
identify a set of related input queries from the plurality of input queries for which no response is available; and
in response to the set of related input queries being greater than a threshold, generate a notification for a manufacturer indicating a desired vehicle feature based on the related input queries.

13. A vehicle control method for vehicle query resolution services, the vehicle control method comprising:
generating a plurality of embeddings based on vehicle specific information and user manuals;
receiving an input query from a user specific to a vehicle;
identifying vehicle information for the vehicle based on the input query;
generating a response with at least one recommendation specific to the vehicle based on the vehicle information and the plurality of embeddings in response to the input query; and
controlling at least one operation of the vehicle based on the at least one recommendation specific to the vehicle.

14. The vehicle control method of claim 13, wherein controlling the at least one operation of the vehicle includes automatically controlling the at least one operation of the vehicle in response to the at least one recommendation.

15. The vehicle control method of claim 13, wherein:
the vehicle control method further includes receiving a user input indicating approval of the at least one recommendation specific to the vehicle; and
controlling the at least one operation of the vehicle includes controlling the at least one operation of the vehicle based on the at least one recommendation specific to the vehicle in response to the user input.

16. The vehicle control method of claim 13, wherein:
the plurality of embeddings for the vehicle specific user manuals are a plurality of first embeddings;
the vehicle control method further includes receiving a plurality of previous input queries and a corresponding plurality of responses to the previous input queries, determining subsets of frequently asked queries from the input queries, the subsets of frequently asked queries specific to different vehicle models, and generating a plurality of second embeddings for the subsets of frequently asked queries specific to the different vehicle models and their corresponding responses; and
generating the response specific to the vehicle includes generating the response based on the vehicle information, the plurality of first embeddings, and the plurality of second embeddings in response to the input query.

17. The vehicle control method of claim 13, wherein:
the vehicle control method further includes receiving at least one condition associated with the vehicle; and
generating the response specific to the vehicle includes generating the response based on the vehicle information, the plurality of embeddings, and the at least one condition associated with the vehicle in response to the input query.

18. The vehicle control method of claim 13, further comprising:
receiving a plurality of input queries;
identifying a set of related input queries from the plurality of input queries for which no response is available; and
in response to the set of related input queries being greater than a threshold, generating a notification for a manufacturer indicating a desired vehicle feature based on the related input queries.

19. A vehicle system for vehicle query resolution services, the vehicle system comprising:
a conversion module configured to receive vehicle specific information and user manuals and generate a plurality of embeddings for the vehicle specific information and user manuals;
a control module in communication with the conversion module, the control module including a large language model configured to receive the plurality of embeddings and an input query from a user specific to a vehicle, identify vehicle information for the vehicle based on the input query, and generate a response with at least one recommendation specific to the vehicle based on the vehicle information and the plurality of embeddings in response to the input query; and
a vehicle control module positioned in the vehicle, the vehicle control module configured to control at least one operation of the vehicle based on the at least one recommendation specific to the vehicle.

20. The vehicle system of claim 19, wherein the vehicle control module configured to control the at least one operation of the vehicle based on the at least one recommendation in response to a user input indicating approval of the at least one recommendation.
